(19) United States
(12) Patent Application Publication
(10) Pub. No.: US 2026/0059033 A1
(43) Pub. Date: Feb. 26, 2026

(54) Soundproofable Device Case

(71) Applicant: Bodyguard Technologies Inc., Marblehead, MA (US)

(72) Inventors: Ryan F. McLaughlin, Marblehead, MA (US); Friedrich G. Geck, Mount Airy, MD (US)

(21) Appl. No.: 19/304,899

(22) Filed: Aug. 20, 2025

Related U.S. Application Data
(60) Provisional application No. 63/686,774, filed on Aug. 24, 2024.

(51) Int. Cl. H04M 1/02; A45C 11/00

(52) U.S. Cl. CPC H04M 1/0203; A45C 11/002

(57) ABSTRACT

A privacy case for an electronic device having at least one microphone and at least one camera. The privacy case can include a housing member for securing to the electronic device. At least one movable privacy cover can be movably mounted relative to the housing member for selectively covering or uncovering the at least one microphone and the at least one camera of the electronic device. An activation mechanism can be connected to the at least one movable privacy cover. The activation mechanism can be configured for being activated in a single movement by a user for moving the at least one movable privacy cover for covering or uncovering simultaneously the at least one microphone and the at least one camera of the electronic device.

### RELATED APPLICATION

This application claims the benefit of U.S. Provisional Application No. 63/686,774, filed on Aug. 24, 2024. The entire teachings of the above application are incorporated herein by reference.

### BACKGROUND

Electronic devices are an everyday part of peoples live, these devices however, come with unwanted consequences. Many people are concerned with these devices potential to invade their privacy in different ways. Electronic devices that include microphones may have the ability to record or listen to people speaking or doing other activities at times when users do not desire to be listened to or recorded. Therefore, it is necessary to provide protection from these potential breaches of privacy.

### SUMMARY

A case partially or fully surrounds an electronic device. The case has multiple movable microphone covers that are attached to the body of the case in both the open and closed positions. The movable covers prevent sound from travelling to the microphones in the closed position and allow sounds to travel to the microphone in the open position.

In embodiments in the present disclosure, the case can be a privacy case for an electronic device having at least one microphone and at least one camera. The privacy case can include a housing member for securing to the electronic device. At least one movable privacy cover can be movably mounted relative to the housing member for selectively covering or uncovering the at least one microphone and the at least one camera of the electronic device. An activation mechanism can be connected to the at least one movable privacy cover. The activation mechanism can be configured for being activated in a single movement by a user for moving the at least one movable privacy cover for covering or uncovering simultaneously the at least one microphone and the at least one camera of the electronic device.

In particular embodiments, the electronic device can be a smart phone, and the privacy case can include at least two movable privacy covers that are moved simultaneously by the activation mechanism. The activation mechanism can be positioned within the housing member, and include an activation member that extends through a wall opening in the housing member for activating the activation mechanism. The activation mechanism can be connected to upper and lower movable privacy covers and can be configured to move the upper and lower movable privacy covers both simultaneously towards each other and simultaneously away from each other. The activation mechanism can be a sliding mechanism and the activation member can extend from a first slide member. At least one movable privacy cover can be connected to and movable by the first slide member. A second slide member can be slidably mounted relative to the first slide member. At least one movable privacy cover can connected to and movable by the second slide member.

In some embodiments, the activation mechanism can include a rack and pinion mechanism, and the activation member can be connected to a gear rack. The gear rack can be a central gear rack. At least one lower movable privacy cover can be connected to the central gear rack, and at least one upper movable privacy cover can be connected to an outer gear rack. The outer gear rack can be movable in opposite directions relative to the central gear rack by at least one pinion gear engaged between the central gear rack and the outer gear rack. The central gear rack can include two sets of linear positioned gear teeth facing in opposite outwardly directions, and the outer gear rack can include two sets of linear positioned gear teeth facing inwardly towards each other, with two pinion gears therebetween on opposite sides of the central gear rack.

The present disclosure can also provide a privacy case for a smart phone having at least one microphone and at least one camera. The privacy case can include a housing member for securing to the smart phone. Upper and lower movable privacy covers can be movably mounted relative to the housing member for selectively covering or uncovering the at least one microphone and the at least one camera of the smart phone. An activation mechanism can be connected to the upper and lower movable privacy covers. The activation mechanism can be configured for being activated in a single movement by a user for moving the upper and lower movable privacy covers for covering or uncovering simultaneously the at least one microphone and the at least one camera of the smart phone. The activation mechanism can include a rack and pinion mechanism with an activation member being connected to a gear rack.

The present disclosure can also provide a method of operating a privacy case for an electronic device having at least one microphone and at least one camera. The privacy case can include a housing member for securing to the electronic device. At least one movable privacy cover can be movably mounted relative to the housing member with an activation mechanism. The activation mechanism can be activated in a single movement by a user for moving the at least one movable privacy cover for covering or uncovering simultaneously the at least one microphone and the at least one camera of the electronic device.

In particular embodiments, the electronic device can be a smart phone, and the privacy case can include at least two movable privacy covers that are moved simultaneously by the activation mechanism. The activation mechanism can be positioned within the housing member, and includes an activation member that extends through a wall opening in the housing member for activating the activation mechanism. The activation mechanism can be connected to upper and lower movable privacy covers. The activation member can activate the activation mechanism to move the upper and lower movable privacy covers both simultaneously towards each other and simultaneously away from each. The activation mechanism can include a sliding mechanism and the activation member can extend from a first slide member. At least one movable privacy cover can be connected to and movable by the first slide member. A second slide member can be slidably mounted relative to the first slide member. At least one movable privacy cover can be connected to and movable by the second slide member.

The activation mechanism can include a rack and pinion mechanism. The activation member can be connected to a central gear rack. At least one lower movable privacy cover can be connected to the central gear rack. At least one upper movable privacy cover can be connected to an outer gear rack. The outer gear rack can be moved in opposite directions relative to the central gear rack with at least one pinion gear engaged between the central gear rack and the outer gear rack. The central gear rack can include two sets of linear positioned gear teeth facing in opposite outwardly directions, and the outer gear rack can include two sets of linear positioned gear teeth facing inwardly towards each other, with two pinion gears therebetween on opposite sides of the central gear rack.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

Some embodiments of the invention are illustrated below as examples. It should be understood that the invention is not limited to these illustrations which are merely meant as examples and that systems described below can me embodied in various ways. In which:

FIGS. 1A and 1B illustrates a back view of an embodiment of a device privacy case in the present disclosure with microphone and camera covers in the open and closed positions.

FIGS. 2A-2D are schematic side and rear views of the embodiment of FIGS. 1A and 1B in closed and open positions, showing the inner workings of the spring mechanism used to open and close the case.

FIGS. 3A-3E illustrates a device privacy case of the embodiment of FIGS. 1A and 1B with a smart phone in an exploded view, complete with attachments and mechanisms (FIG. 3A); a backside view with microphone/camera covers in open position (FIG. 3C); a backside view with the microphone/camera covers in the closed position (FIG. 3E); a frontside view with the microphone/camera covers in open position (FIG. 3B); and a frontside view with the microphone/camera covers in the closed position (FIG. 3D).

FIG. 4 is an exploded view of another embodiment of a device privacy case complete with attachments and mechanisms. Camera shutter, microphone covers, soundproof foam and general functionality are shown in detail.

FIGS. 5A-5D are front, side, back and perspective views of the device privacy case of FIG. 4. A shutter switch is shown from the back view, as well as the dimensions and measurements of case.

FIGS. 6A-6F are exploded, front side, back and perspective views of an embodiment of a device privacy case. FIG. 6A shows an exploded front view of the device privacy case with components detailed. FIGS. 6B-6F illustrate the device privacy case including mechanisms used to open and shut camera/microphone covers.

FIGS. 7A-7F are exploded, front, rear, left side, right side and perspective views of another embodiment of a device privacy case in the present disclosure.

FIGS. 8A and 8B are front and rear views of the device privacy case of FIGS. 7A-7F containing a smart phone, with the privacy covers positioned in the uncovered or open position.

FIGS. 9A-9F are front, rear, left side, right side, top and bottom views of the device privacy case of FIGS. 7A-7F containing a smart phone, with the privacy covers positioned in the covered or closed position.

### DETAILED DESCRIPTION

A description of example embodiments follows.

The terminology used herein is for the purpose of describing particular embodiments only and is not intended to be limiting of the invention. As used herein, the term “and/or” includes any and all combination of one or more of the associated listed items. As used herein, the singular forms, unless the context clearly indicates otherwise. It will be further understood that the terms “comprises” and/or “comprising” when used in the specification, specify the presence of stated features, steps, operation, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that several techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combination are entirely within the scope of the invention and the claims.

Methods for using a case to prevent device microphones from hearing unwanted sounds are described herein. In the following description, for purposes of explanation, numerous specific details are set forth in order to provide a thorough understanding of the present disclosure. It will be evident, however, to one skill in the art that the present disclosure may be practiced without these specific details.

The present disclosure is to be considered as an explanation of the invention, and is not intended to limit the invention to the specific embodiments illustrated by the figure or description below.

In the illustrations featured below, a three-microphone device is depicted, however, this is not intended to be limiting of the invention. It should be understood that different devices have different amounts of microphones, located at different points on the device and that additional covers or sound resistant apparatuses located at various points on the case would be required to soundproof different devices.

The present disclosure will now be described by the referencing the appended figures representing preferred embodiments.

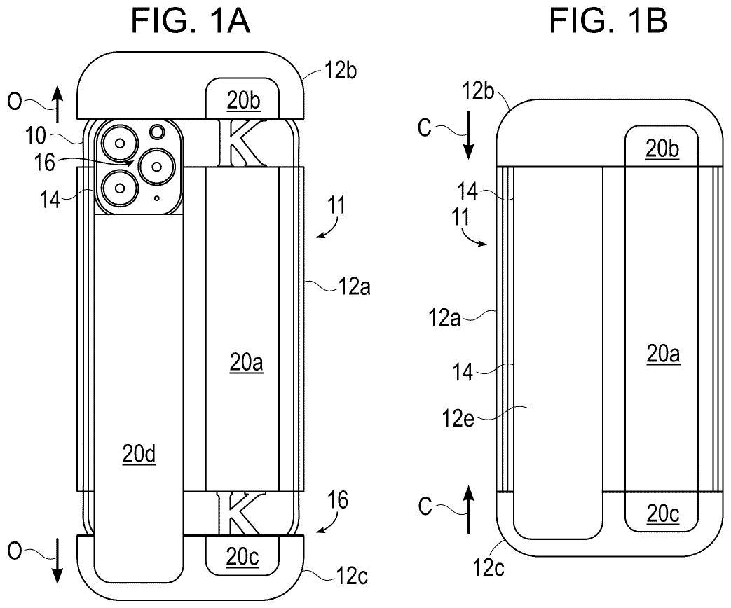

In FIGS. 1A and 1B, the back is shown of one embodiment. The rear microphone cover is in the open position (FIG. 1A, Left) and the microphone can be seen. The rear microphone cover is in the closed position (FIG. 1B, Right) and the microphone cannot be seen. The cover is restricting sound from travelling to the microphone.

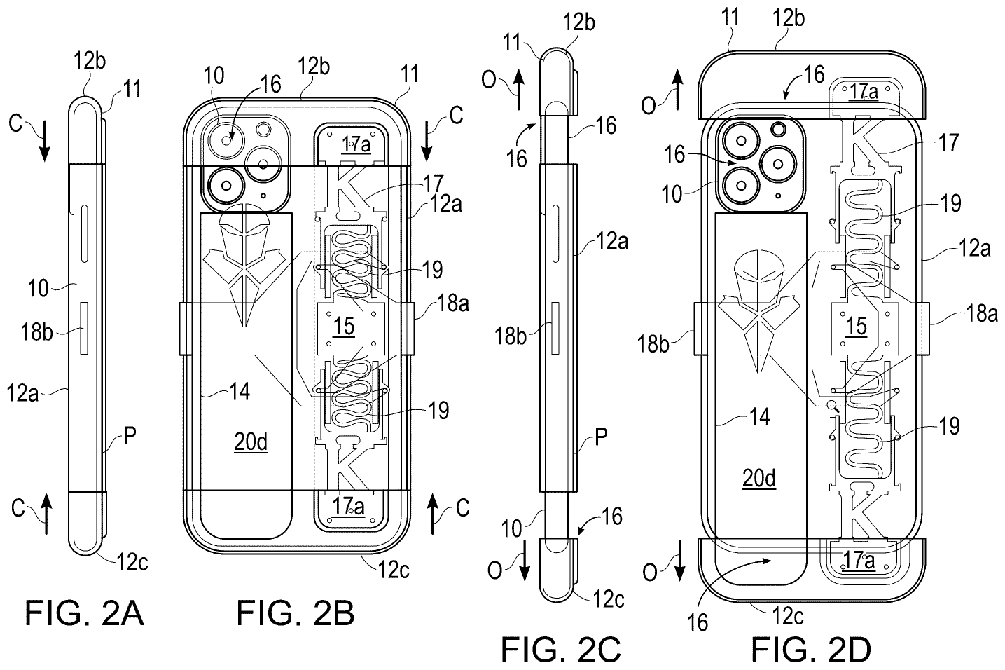

In FIGS. 2A-2D, the back is shown schematically. The rear microphone cover is in the open position (FIGS. 2C and 2D, Right) and the microphone can be seen. The rear microphone cover is in the closed position (FIGS. 2A and 2B, Left) and the microphone cannot be seen. This view is depicting the inner workings of the spring mechanism used to open and close the case.

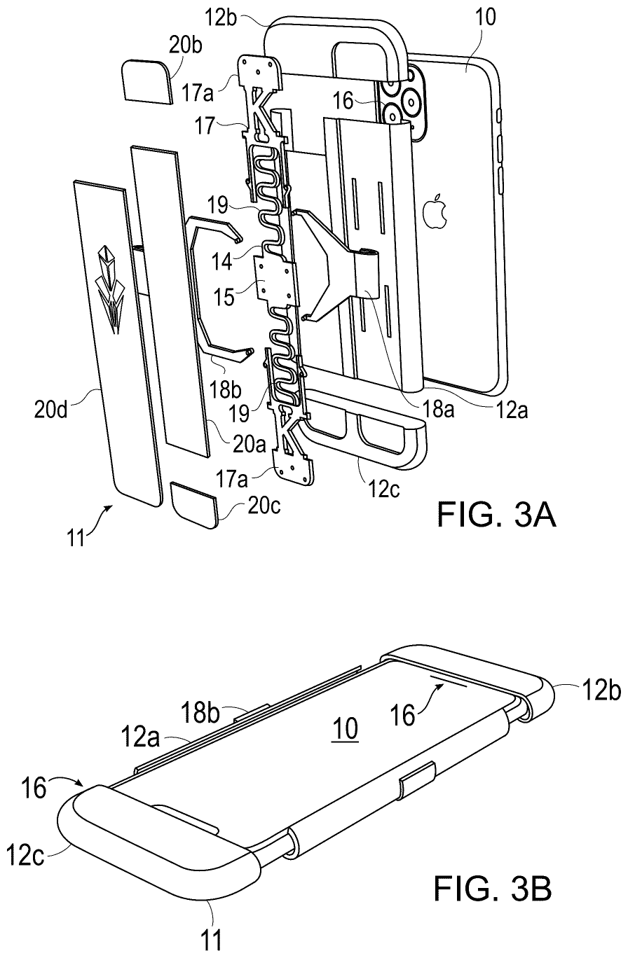

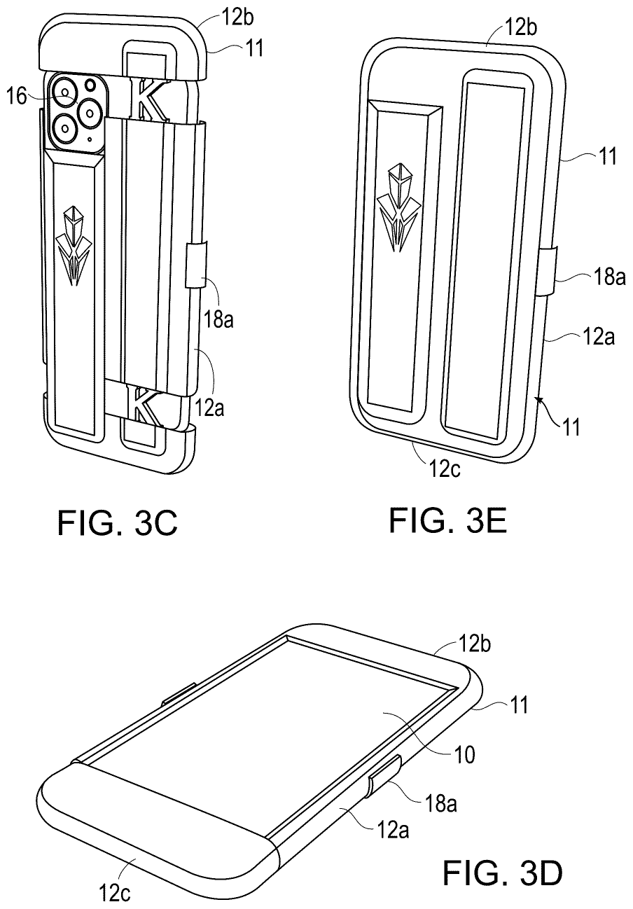

In FIGS. 3A-3E, the front view (FIGS. 3B and 3D), back view (FIGS. 3C and 3E), and an exploded view (FIG. 3A) are shown.

In FIGS. 1A-3E, in one embodiment, an electronic communication device such as a smart phone 10 can be contained within a communication device or phone privacy enclosure, cover, housing or case 11, which can provide soundproofing and camera privacy to the smart phone 10. The smart phone 10 can include interactive or communication device features or components 16, such as at least one microphone, at least one camera and/or at least one audio speaker, located at upper and lower regions of the smart phone 10. For example, the top front of the smart phone 10 can have components 16 that include at least one front microphone and front speaker, the top rear of the smart phone 10 can have components 16 including at least one rear camera and rear microphone, and the bottom of the smart phone 10 can include at least one bottom microphone and bottom speaker. In some embodiments, the top edge of the smart phone 10 can also include components 16 such as a top microphone.

The privacy case 11 can include a main or central enclosure, body, housing or housing member 12a for securing to or at least partially surrounding the smart phone 10, a movable first or lower privacy cover 12c and a movable second or upper privacy cover 12b. An elongate flat or planar spring activation mechanism 17 can be operably connected to activation buttons or members 18a and 18b, can be mounted within or to the housing member 12a. The activation mechanism 17 can have flat or planar lower and upper spring members 19, aligned on opposite sides of a flat or planar mount 15. The distal ends 17a of the activation mechanism 17 can be connected to the lower privacy cover 12c and the upper privacy cover 12b respectively, for moving the privacy covers 12c and 12b simultaneously in open and closed positions, as indicated by arrows O and C along a common plane P, for simultaneously covering or uncovering the interactive components 16. The activation members 18a and 18b can extend through openings in the side of housing member 12a for operation by the user. A cover 20a can be positioned over the activation mechanism 17, and covers 20b and 20c can be positioned on or over respective privacy covers 12b and 12c. A cover 20d can be secured to lower privacy cover 12c for sliding within slot 14 on housing member 12a for covering and uncovering particular device components 16 as shown. The activation members 18a and 18b can be activated by the user for simultaneously releasing privacy covers 12b and 12c in opposite directions away from each other, sliding open in the direction of arrows O for uncovering device components 16. In some embodiments, the privacy covers 12b and 12c can be simultaneously closed in the direction of arrows C by simultaneously pushing the privacy covers 12b and 12c in opposite directions towards each other for covering the device components 16. For example, the upper privacy cover 12b can be pushed downwardly by a hand while the lower privacy cover 122c is against or on top of a surface, such as a table.

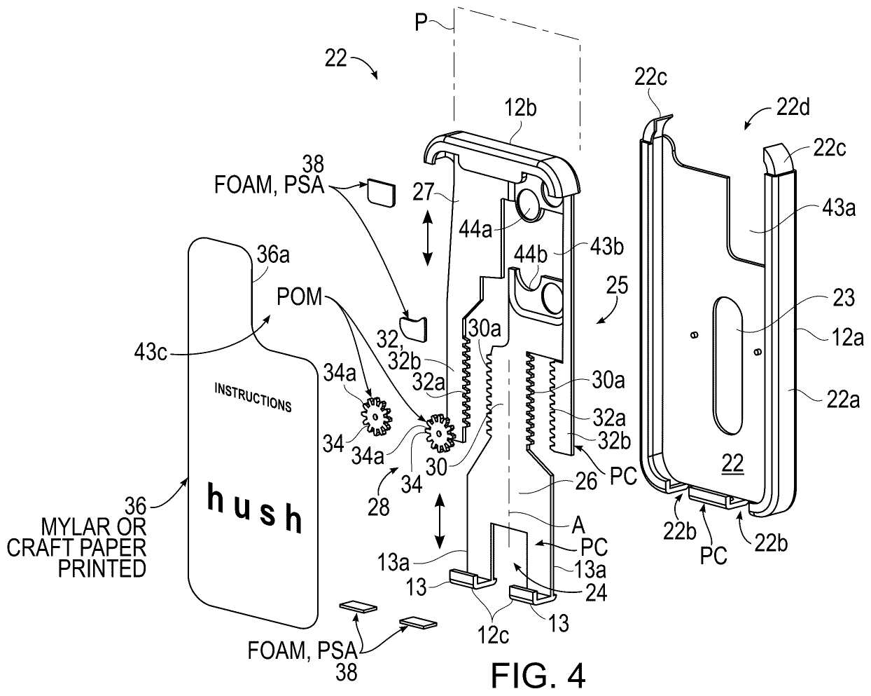

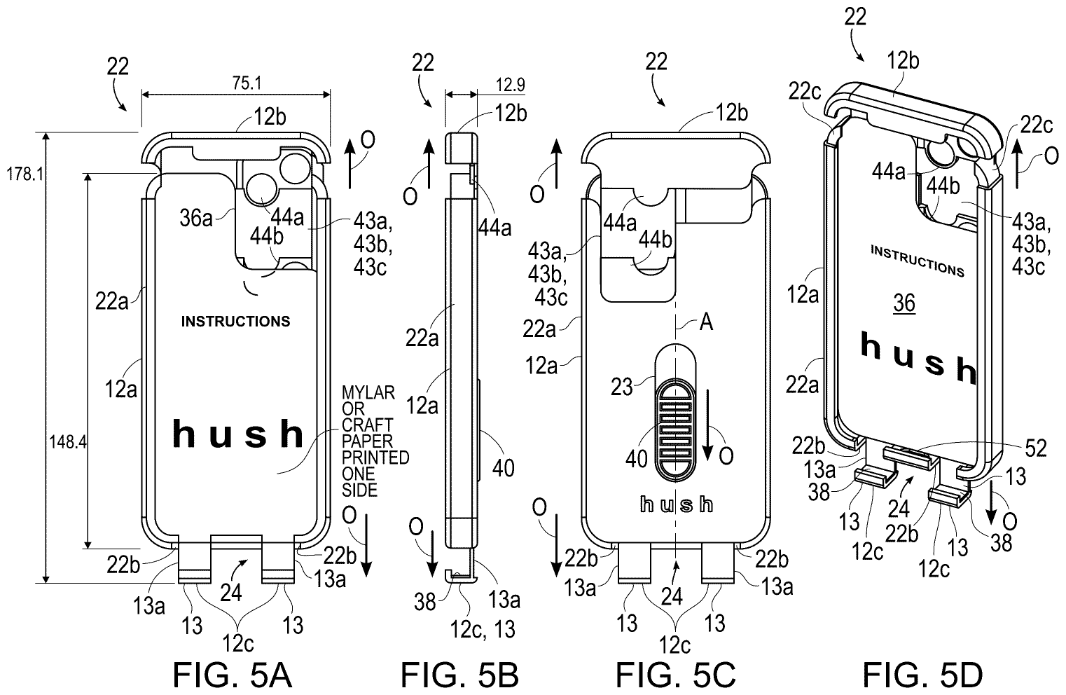

FIGS. 4-5D disclose another embodiment of a communication device or phone privacy enclosure, cover, housing or case 22, that can provide soundproofing and camera privacy to a smart phone 10 contained therein. The privacy case 22 can have a housing member 12a, a sliding or slide activation mechanism 25 attached to the privacy covers 12b and 12c, and a mechanism cover 36. The housing member 12a can have flat or planar back or rear wall 22, and side walls 22a for securing a smart phone 10 therein. The bottom can have a pair of openings 22b extending through side wall 22a, and the top can have a pair of upper curved tips 22c with an open space 22d therebetween. A generally rectangular window opening 43a can extend downwardly into the rear wall 22 from the open space 22d. A centrally located opening or slot 23 can extend through the mid to lower portion of the rear wall 22, and in alignment with a central axis A.

The slide mechanism 25 can be generally flat or planar, and include a generally flat or planar first or lower slide member 26, and a generally flat or planar second or upper slide member 27, slidably positioned or mounted within the interior of the housing member 12a against the rear wall 22. The slide members 26 and 27 can be slidable relative to each other and rear wall 22, and lie along a common plane P, sandwiched between the rear wall 22 and the mechanism cover 36. The lower slide member 26 can have two lower legs 13a separated by a lower gap 24 on opposite sides of central axis A, that are extendable through respective openings 22b in the bottom of the housing member 12a. Laterally extending bottom feet 13 can extend from respective legs 13a, and form two parts or halves of the lower privacy cover 12c. Each half of the lower privacy cover 12c can have rear, bottom and front portions for covering two locations on the bottom end of smart phone 10. Sound absorbing foam pads or members 38 can be attached to the upper surfaces of the bottom feet 13 with pressure sensitive adhesive (PSA) for blocking sound to or from microphones or speakers on the bottom of smart phone 10. The upper privacy cover 12b can be connected to or extend from the upper slide member 27 for covering or uncovering the top of the smart phone 10. The upper privacy cover 12b can have rear, top, front and end portions for covering the top end of the smart phone 10. When the upper privacy cover 12b is in the closed position, curved ends of the upper privacy cover 12b can engage over the upper curved tips 22c of the housing member 12a.

The slide mechanism 25 can also include a generally flat or planar rack and pinion activation mechanism 28 that can lie along plane P. The rack and pinion mechanism 28 can be part of the slide mechanism 25, or attached thereto. The rack and pinion mechanism 28 can include a generally flat or planar central gear rack 30 that is part of lower slide member 26 extending upwardly relative to the lower legs 13a and lower privacy cover 12c along central axis A. The central gear rack 30 can have two elongate sets or rows of generally planar linear positioned gear teeth 30a parallel to central axis A facing outwardly away from each other from opposite linear sides of central rack 30. The back side or rear of the lower slide member 26 can have a activation or slide button, protrusion, knob or member 40 (FIG. 5C) extending therefrom, for extending or protruding through the slot 23 in the rear wall 22 of the housing member 12a for activating the slide mechanism 25.

The upper slide member 27 can include a twin or double generally flat or planar outer gear rack 32 having two spaced apart generally flat or planar outer gear rack members 32b extending downwardly relative to the upper privacy cover 12b on opposite sides of the central axis A and central gear rack 30. The two outer gear rack members 32b can each have an elongate set or row of generally planar linear positioned gear teeth 32a parallel to central axis A facing inwardly towards each other from opposite sides. The gear teeth 30a of the central gear rack 30 and the gear teeth 32a of the outer gear rack members 32b face each other on opposite sides of the central axis A in a spaced apart manner. Two generally flat or planar pinion gears 34 can be positioned in alignment with each other on opposite sides of the central gear rack 30 within the two spaces between the central gear rack 30 and the outer gear rack member 32b, with the gear teeth 34a of each pinion gear 34 simultaneously engaging gear teeth 30a of the central gear rack 30 and gear teeth 32b of an outer gear rack member 32b. The two pinion gears 34 rotate in opposite directions from each other during movement of the slide members 26 and 27, one clockwise, and the other counter clockwise. The gear racks 30 and 32, pinion gears 34, and slide members 26 and 27, can all lie generally on plane P. Interaction of the two pinion gears 34 with gear racks 30 and 32 can provide controlled sliding movement of the slide members 26 and 27 relative to each other, where movement of the lower slide member 26 by the slide button 40 causes an equal amount of movement of the upper slide member 27 in the opposite direction in a 1:1 ratio, either towards or away from each other. This in turn can provide the privacy covers 12b and 12c with equal and opposite movement relative to each other for covering and uncovering interactive device components 16 of the smart phone 10.

An upper privacy shutter half or portion 44a can extend downwardly from the upper privacy cover 12b generally along plane P, and a lower privacy shutter half or portion 44b can extend upwardly from the lower slide member 26 and central gear rack generally along plane P. The upper slide member 27 can have a window opening 43b below the upper privacy shutter portion 44a between the outer gear rack members 32b for aligning with the window opening 43a of the housing member 12a. Movement of the slide members 26 and 27 towards each other causes the shutter portions 44a and 44b join or mate together within the window opening 43b, thereby closing the window opening 43b and covering the interactive device components 16 aligned with the window opening 43b. Movement of the slide members 26 and 27 away from each other cause the shutter portions 44a and 44b to separate and move away from each other, thereby opening the window opening 43b and uncovering the interactive device components 16 aligned therewith. The lower shutter portion 44b can slide within the window opening 43b, slidably engaging the sides of the window opening 43b. Sound absorbing pads or members 38 can be attached with pressure sensitive adhesive to selected surfaces of the shutter portions 44a and 44b, and upper privacy cover 12b, for blocking sound to or from microphones or speakers.

The mechanism cover 36 can be mounted or positioned within housing member 12a over the slide mechanism 25 for separating the slide mechanism 25 from the smart phone 10, when the smart phone is contained within privacy case 22. The mechanism cover 36 can have a cutout 36a forming a window opening 43c that aligns with window openings 43a and 43b to allow the interactive device components 16 on the upper rear or back of the smart phone 10 to be aligned therewith for selected covering or uncovering by shutter portions 44a and 44b.

Referring to FIGS. 5A-5D, when the slide button 40 is moved in a single motion along axis A by a user's finger such as the thumb downwardly in the opening direction indicated by arrow O, the lower slide member 26 and the lower privacy cover 12c are moved downwardly as indicated by arrow O to uncover interactive device components 16 on the bottom of the smart phone 10. The legs 13a of the lower slide member 26 move downwardly through openings 22b of the housing member 12a and the feet 13 of the lower privacy cover 12c move downwardly away from the device components 16. The lower privacy shutter portion 44b also moves downwardly with the lower slide member 26 for uncovering the bottom portion of the window openings 43a, 43b and 43c. The pinion gears 34 of the rack and pinion mechanism 28 cause simultaneous movement of the upper slide member 27 and upper privacy cover 12b in the opposite upward direction an equal amount for opening in the direction of arrow O, thereby lifting and uncovering the top of the smart phone 10, as well as moving the upper shutter portion 44a upwardly, thereby extending window opening 43b upwardly and uncovering the upper portion of the window openings 43a and 43c. When the privacy covers 12b and 12c and shutter portions 44a and 44b are in the closed position, device components 16 such as microphones, speakers and cameras are covered and restricted from use or detection, of sound and images. When the privacy covers 12b and 12c and shutter portions 44a and 44b are in the open position, the device components 16 can be used. In some embodiments, the lower shutter portion 44b can be considered part of the lower privacy cover 12c, and the upper shutter portion 44a can be considered part of the upper privacy cover 12b.

In some embodiments, referring to FIGS. 5A and 5B, the privacy case 22 can be about 75.1 mm wide and 12.9 mm thick. In the closed position, the height can be about 148.4 mm, and in the open position, the distance from the bottom of lower privacy cover 12c to the top of upper privacy cover 12b can be about 178.1 mm. The housing member 12a, privacy covers 12b and 12c, slide members 26 and 27, gear racks 30 and 32, and pinion gears 34 can be made of a suitable plastic or polymer, such as polycarbonate. The mechanism cover 36 can be formed of a sheet of mylar or craft paper. Since the slide mechanism 25 is positioned against the interior surface of wall 22 of the housing member 12a and the smart phone 10 is positioned over the mechanism cover 36 and the slide mechanism 25, the lower 12c and upper 12b privacy covers have lateral surfaces as well as external vertical surfaces that extend forwardly in a cantilevered manner to cover the bottom and top ends as well as front surfaces of the bottom and top ends of the smart phone 10.

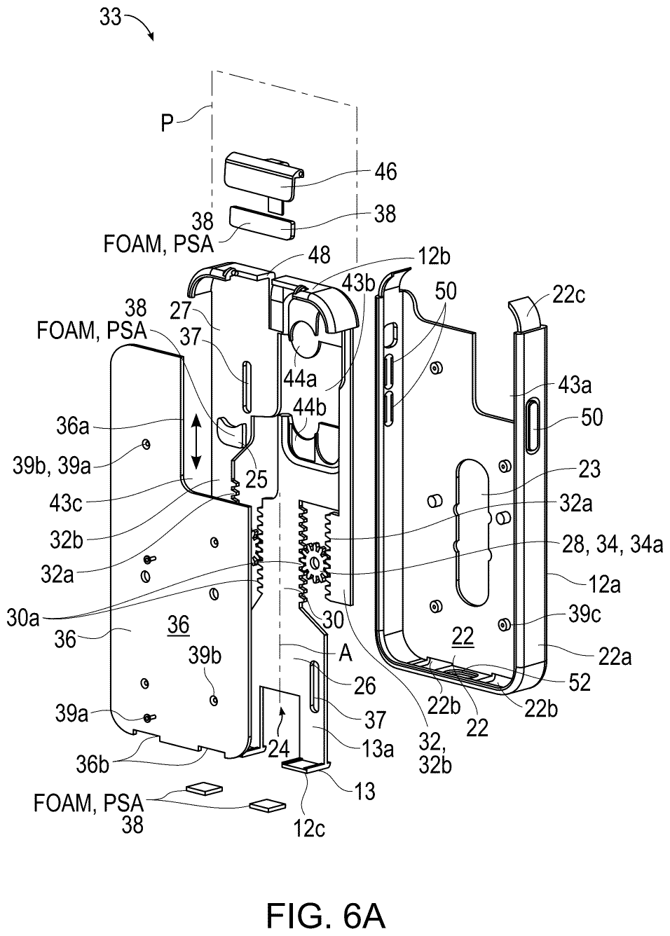

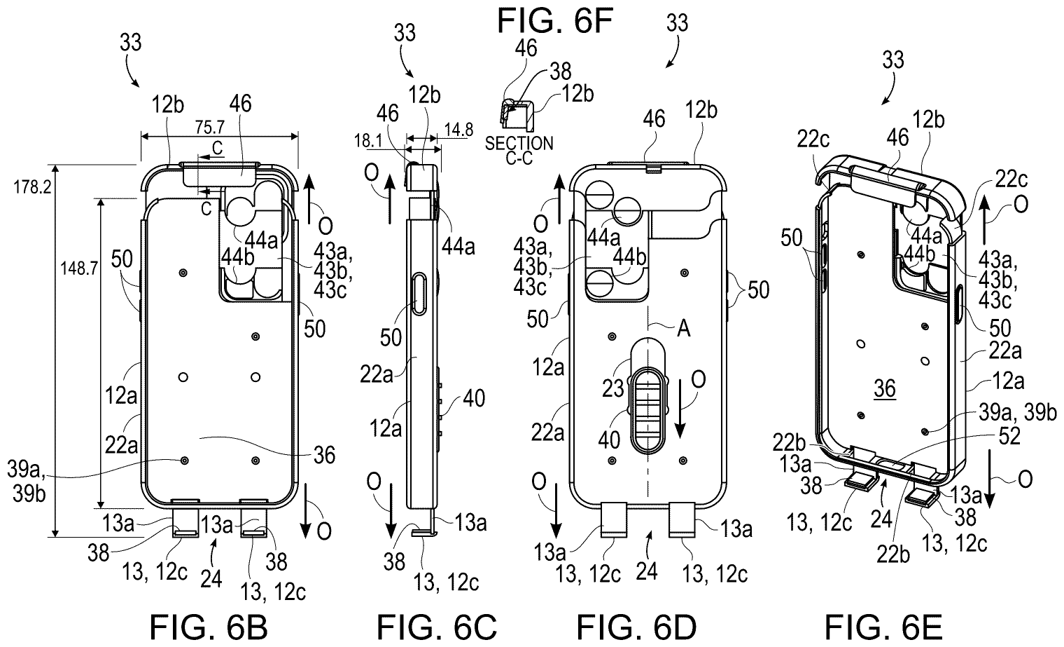

Referring to FIGS. 6A-6E, privacy cover 33 differs from privacy cover 22 in that the housing member 12a can have button extension members 50 on the side walls 22a for engaging aligned buttons on the smart phone 10, for allowing operation of the buttons on the smart phone 10. The bottom side wall 22a of the housing member 12a can have openings 22b for legs 13a extending therethrough, and a charging port window 52 positioned therebetween. The rear wall 22 can have a series of screw mounts 39c for alignment with holes 39b in mechanism cover 36 for securement of the slide mechanism 25 and mechanism cover 36 thereto with screws 39a. The mechanism cover 36 can be formed of a sheet of plastic or polymer such as polycarbonate. As a result, the slide mechanism 25 can be slidably contained or sandwiched between and against the mechanism cover 36 and the rear wall 22 of the housing member 12a. The lower 26 and upper 27 slide members can have slotted openings, holes or slots 37 through which screws 39a can extend through for securement to the rear wall 22 of housing member 12a while still allowing the slide members 26 and 27 to move up and down. The slots 37 can also act as guides for the slide members 26 and 27 during sliding, and can help keep the slide members 26 and 27 in proper alignment. The upper privacy cover 12b can have a separate top cover piece or member 46 which engages an opening 48 in the upper privacy cover 12b and can have a foam pad or member 38 secured to an inner facing lateral surface with pressure sensitive adhesive for covering device features or components 16 on the top front of the smart phone 10.

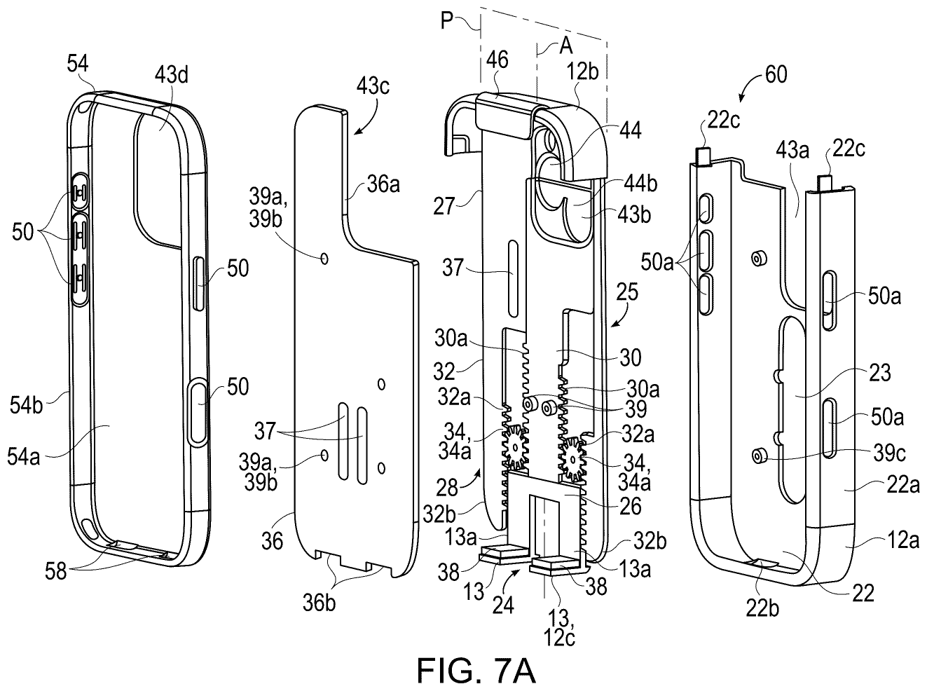

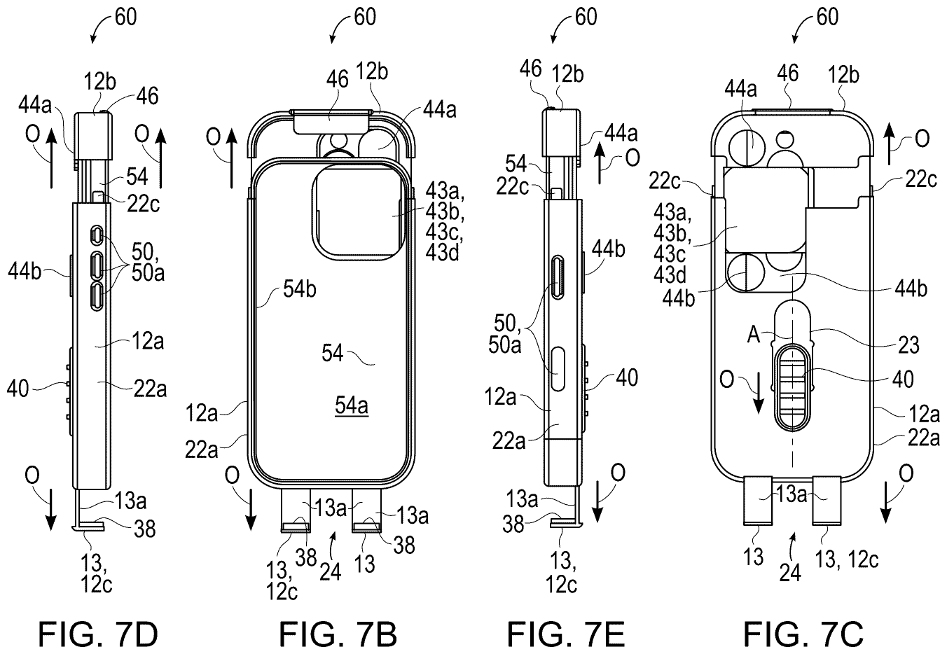

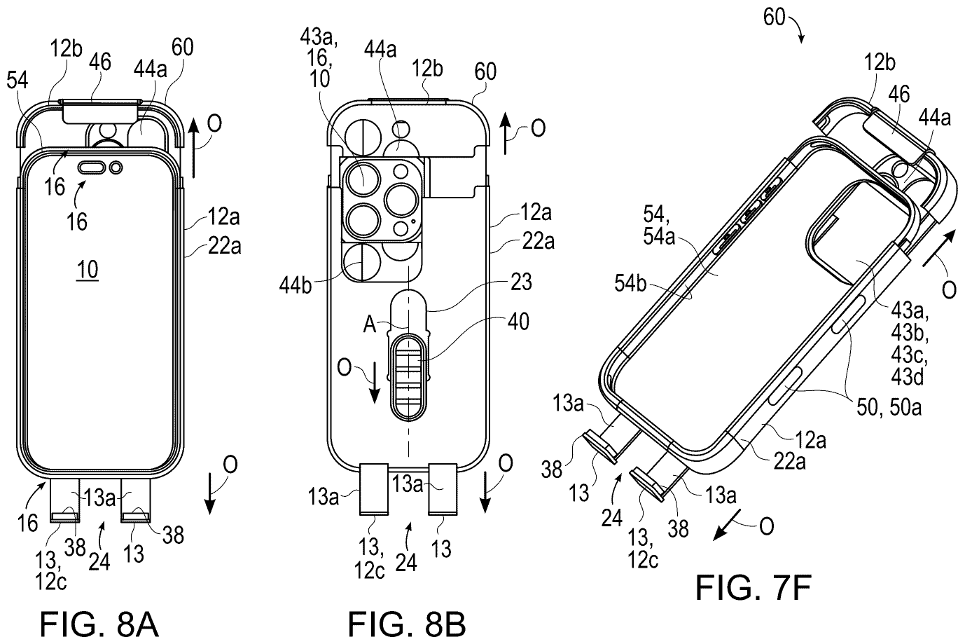

Referring to FIGS. 7A-9F, privacy cover 60 differs from privacy cover 33, by including a phone insert 54 for containing smart phone 10, which is inserted into the housing member 12a over or against the mechanism cover 36. The phone insert 54 includes a rear wall 54a and a side wall 54b for containing the smart phone 10 therein. A window opening 43d extends through the rear wall 54a for alignment with window openings 43a, 43b, and 43c, for aligning with certain interactive device components 16 on the back of the smart phone 10. The side wall 54b can include button extension members 50 for engaging aligned buttons on the smart phone 10. The button extension members 50 can extend through corresponding button openings 50a on the side walls 22a of the housing member 12a for allowing operation of the smart phone 10. The bottom of the side wall 54b can have openings 58 for aligning with device components 16 on the bottom of the smart phone 10, such as microphones and speakers. The upper tips 22c of the housing member 12a can be short straight tabs for engaging recessed slots on opposite inner sides of the upper privacy cover 12b, when the privacy cover 12b is in the closed position. The central rack 30 of the lower slide member 26 can extend from a lateral bar connecting the two legs 13a together, and can be positioned closer to the legs 13a than in privacy covers 22 and 33. The central rack 30 can include two laterally spaced apart guide protrusions 39 on opposite sides of axis A for engaging respective elongate slots 37 within the mechanism cover 36, for helping keep lower slide member 26 in proper alignment during sliding movement. Two lower screws 39a can extend through holes 39b in mechanism cover 36, through central axis holes within pinion gears 34 and into screw mounts 39c for securing the pinion gears 34 at fixed rotational positions.

In use, activation of the slide button 40 on the back of the privacy cover 60 along axis A in the direction of arrow O in a single movement by the user (FIGS. 7B-8B), can simultaneously move the lower 12c and upper 12b privacy covers and the lower 44b and upper 44a shutter portions, away from each other in the direction of arrows O to uncover the interactive device components 16 located on the bottom, top, top front, and top rear of the smart phone 10, allowing the user to use microphones, speaker and cameras of the smart phone 10.

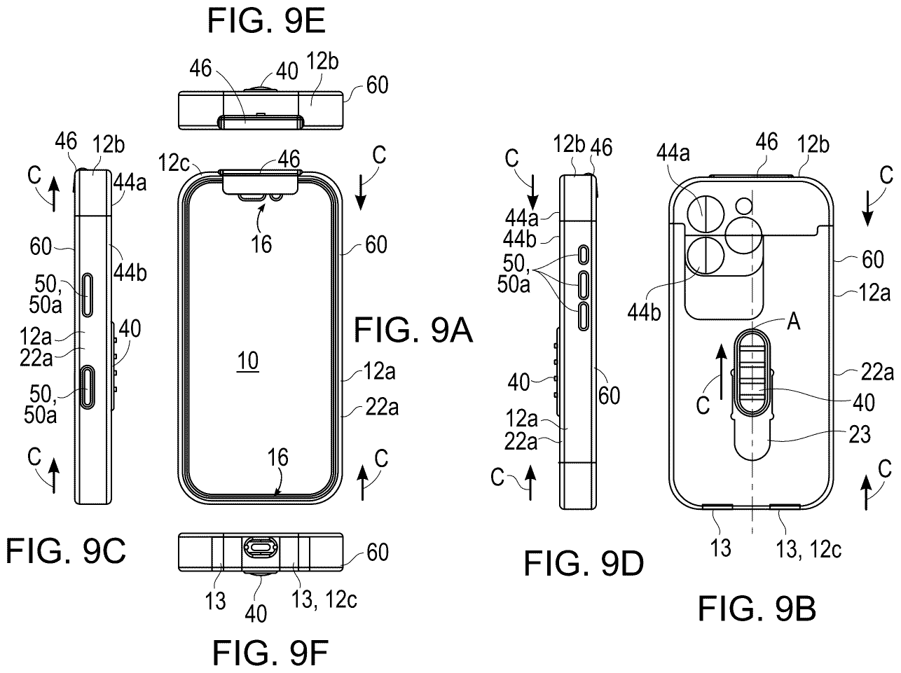

Activation of the slide button 40 along axis A in the direction of arrow C in a single movement by the user (FIGS. 9A-9F) can simultaneously move the lower 12c and upper 12b privacy covers and the lower 44b and upper 44a shutter portions, towards each other to cover the device components 16 located on the bottom, top, top front, and top rear of the smart phone 10, providing privacy for the smart phone 10 with regard to transmitting sound, receiving sound, or receiving images.

While example embodiments have been particularly shown and described, it will be understood by those skilled in the art that various changes in form and details may be made therein without departing from the scope of the embodiments encompassed by the appended claims.

Although terms such as lower, upper, top bottom, rear, back, front, etc. have been used in describing the embodiments in the present disclosure, it is understood that this is described for the normal orientation of holding the smart phone 10 and privacy cover, and that the smart phone 10 and privacy cover can be held in other orientations. Features of the different embodiments of the present disclosure can be combined together or omitted. It is understood that although a certain smart phone 10 has been shown in the figures, it is understood that other smart phones will have interactive device components 16 in different configurations or locations, so that the exact size and shape of the housing member 12, privacy covers 12b and 12c, and/or shutter portions 44a and 44b can differ, depending upon the model and brand of the smart phone 10.

What is claimed is:

1. A privacy case for an electronic device having at least one microphone and at least one camera, the privacy case comprising:
a housing member for securing to the electronic device;
at least one movable privacy cover movably mounted relative to the housing member for selectively covering or uncovering the at least one microphone and the at least one camera of the electronic device; and
an activation mechanism connected to the at least one movable privacy cover, the activation mechanism configured for being activated in a single movement by a user for moving the at least one movable privacy cover for covering or uncovering simultaneously the at least one microphone and the at least one camera of the electronic device.

2. The privacy case of claim 1 in which the electronic device is a smart phone, and the privacy case includes at least two movable privacy covers that are moved simultaneously by the activation mechanism.

3. The privacy case of claim 2 in which the activation mechanism is positioned within the housing member, and includes an activation member that extends through a wall opening in the housing member for activating the activation mechanism.

4. The privacy case of claim 3 in which the activation mechanism is connected to upper and lower movable privacy covers and is configured to move the upper and lower movable privacy covers both simultaneously towards each other and simultaneously away from each other.

5. The privacy case of claim 4 in which the activation mechanism is a sliding mechanism and the activation member extends from a first slide member, at least one movable privacy cover is connected to and movable by the first slide member, a second slide member is slidably mounted relative to the first slide member, at least one movable privacy cover is connected to and movable by the second slide member.

6. The privacy case of claim 4 in which the activation mechanism includes a rack and pinion mechanism, the activation member being connected to a gear rack.

7. The privacy case of claim 6 in which the gear rack is a central gear rack, at least one lower movable privacy cover is connected to the central gear rack, and at least one upper movable privacy cover is connected to an outer gear rack, the outer gear rack being movable in opposite directions relative to the central gear rack by at least one pinion gear engaged between the central gear rack and the outer gear rack.

8. The privacy case of claim 7 in which the central gear rack includes two sets of linear positioned gear teeth facing in opposite outwardly directions, and the outer gear rack including two sets of linear positioned gear teeth facing inwardly towards each other, with two pinion gears therebetween on opposite sides of the central gear rack.

9. A privacy case for a smart phone having at least one microphone and at least one camera, the privacy case comprising:
a housing member for securing to the smart phone;
upper and lower movable privacy covers movably mounted relative to the housing member for selectively covering or uncovering the at least one microphone and the at least one camera of the smart phone; and
an activation mechanism connected to the upper and lower movable privacy covers, the activation mechanism configured for being activated in a single movement by a user for moving the upper and lower movable privacy covers for covering or uncovering simultaneously the at least one microphone and the at least one camera of the smart phone, the activation mechanism including a rack and pinion mechanism with an activation member being connected to a gear rack.

10. A method of operating a privacy case for an electronic device having at least one microphone and at least one camera, the privacy case comprising a housing member for securing to the electronic device, at least one movable privacy cover being movably mounted relative to the housing member with an activation mechanism, the method comprising:
activating the activation mechanism in a single movement by a user for moving the at least one movable privacy cover for covering or uncovering simultaneously the at least one microphone and the at least one camera of the electronic device.

11. The method of claim 10 in which the electronic device is a smart phone, and the privacy case includes at least two movable privacy covers that are moved simultaneously by the activation mechanism.

12. The method of claim 11 in which the activation mechanism is positioned within the housing member, and includes an activation member that extends through a wall opening in the housing member for activating the activation mechanism, the activation mechanism being connected to upper and lower movable privacy covers, the method further comprising with the activation member, activating the activation mechanism to move the upper and lower movable privacy covers both simultaneously towards each other and simultaneously away from each.

13. The method of claim 12 in which the activation mechanism includes a sliding mechanism and the activation member extends from a first slide member, at least one movable privacy cover is connected to and movable by the first slide member, a second slide member is slidably mounted relative to the first slide member, at least one movable privacy cover is connected to and movable by the second slide member.

14. The method of claim 12 in which the activation mechanism includes a rack and pinion mechanism, the activation member being connected to a central gear rack, at least one lower movable privacy cover is connected to the central gear rack, at least one upper movable privacy cover is connected to an outer gear rack, the method further comprising moving the outer gear rack in opposite directions relative to the central gear rack with at least one pinion gear engaged between the central gear rack and the outer gear rack.

15. The method of claim 14 in which the central gear rack includes two sets of linear positioned gear teeth facing in opposite outwardly directions, and the outer gear rack including two sets of linear positioned gear teeth facing inwardly towards each other, with two pinion gears therebetween on opposite sides of the central gear rack.
